(19) United States
(12) Patent Application Publication
(10) Pub. No.: US 2026/0219417 A1
(43) Pub. Date: Jul. 30, 2026

(54) METHOD AND APPARATUS FOR PROCESSING CT IMAGE AND METHOD AND APPARATUS FOR INSPECTING INTERNATIONAL EXPRESS DELIVERY

(71) Applicants: Nuctech Jiangsu Company Limited, Changzhou (CN); Nuctech Company Limited, Beijing (CN)

(72) Inventors: Zhiqiang CHEN, Beijing (CN); Yuanjing LI, Beijing (CN); Li ZHANG, Beijing (CN); Junwei ZHU, Beijing (CN); Junyu YING, Beijing (CN); Yunda SUN, Beijing (CN); Lei Lei, Beijing (CN)

(21) Appl. No.: 19/144,911

(22) PCT Filed: Dec. 26, 2023
(86) PCT No.: PCT/CN2023/141789

§ 371 Date: Jun. 30, 2025

(30) Foreign Application Priority Data
Dec. 30, 2022 (CN) 202211737683.X

(51) Int. Cl. G01V 5/226; G06T 7/00; G06T 7/12; G06V 10/74; G06V 10/77; G06V 10/82; G06V 20/70

(52) U.S. Cl. CPC G01V 5/226; G06T 7/0008; G06T 7/12; G06V 10/761; G06V 10/7715; G06V 10/82; G06V 20/70; G06T 2207/10081

(57) ABSTRACT

Provided are a method and an apparatus for processing a CT image and a method and an apparatus for inspecting the international express delivery. The method for processing the CT image includes a pre-processing step where uniform sampling and coordinate normalization are performed on three-dimensional data of the CT image to acquire pre-processed data, an object instance acquisition step where object instance data acquired after instance segmentation combined with semantic information is acquired for the pre-processed data, and a structured feature acquisition step where structured features of the object instance data are acquired using a feature extractor trained based on a neural network.

### CROSS-REFERENCE TO RELATED APPLICATIONS

The present application is a National Stage of International Application No. PCT/CN2023/141789, filed on Dec. 26, 2023, which claims priority to Chinese Patent Application No. 202211737683.X, filed on Dec. 30, 2022, and entitled “METHOD AND APPARATUS FOR PROCESSING CT IMAGE AND METHOD AND APPARATUS FOR INSPECTING INTERNATIONAL EXPRESS DELIVERY”, both of which are incorporated herein by reference in their entireties.

### TECHNICAL FIELD

The present disclosure relates to the field of computed tomography (CT) image processing, and particularly, to international express delivery inspection using the intelligent structured description technology for the CT image.

### BACKGROUND

With the widespread popularity of e-commerce, emerging industries such as cross-border e-commerce are developing rapidly, and import and export trade is prosperous day by day. As the total volume of import and export is increasing constantly, the workload of express delivery supervision and inspection is gradually increasing. In the traditional on-site supervision mode for the express delivery, for all parcels entering the supervision center, the actual information of the parcels needs inspecting with the traditional inspection system usually carried out by comparing the X-ray fluoroscopic images with the customs declaration information. When declaring items to the Customs, some dishonest traders make the false statements and conceal the real information of the commodities for the purpose of tax evasion. In addition, some goods that are explicitly prohibited by the Customs from being mailed or carried could be falsely declared as other objects and hidden in the parcels for entry. Most existing inspection systems rely on the fluoroscopic images obtained by scanning of the X-ray machine. However, the position of the X-ray machine in the inspection device is fixed, so that the parcels cannot be scanned from more angles, thereby affecting the imaging effect and causing more omissions and errors in inspection.

In addition, in the past, only the physical feature values of the CT scan images such as the density and the atomic number were utilized in the object inspection, but the three-dimensional shape information obtained by the CT scanning was not fully utilized, and the image features of the declared commodities in the parcels could not be completely described, so that the inventory comparison could not be accurately carried out.

### SUMMARY

According to an embodiment of the present disclosure, a method for processing a CT image is provided. The method for processing the CT image includes a pre-processing step of performing uniform sampling and coordinate normalization on three-dimensional data of the CT image to acquire pre-processed data, an object instance acquisition step of acquiring, for the pre-processed data, object instance data acquired after instance segmentation combined with semantic information, and a structured feature acquisition step of acquiring structured features of the object instance data using a feature extractor trained based on a neural network.

According to the method for processing the CT image of the present disclosure, the object instance acquisition step includes: acquiring, from the pre-processed data, a feature matrix comprising a global feature and a local feature; performing, on the feature matrix, semantic segmentation and instance segmentation with two decoders respectively; embedding a semantic feature acquired after the semantic segmentation into an instance space acquired after the instance segmentation to acquire an instance feature matrix with known semantics; and labeling different instances with instance labels through unsupervised clustering to acquire the object instance after the instance segmentation.

According to the method for processing the CT image of the present disclosure, constructing the feature extractor includes: constructing, based on a Siamese network framework, a three-dimensional metric learning network capable of learning general image features; acquiring source data comprising paired data as training data; and training the three-dimensional metric learning network using the training data to acquire the feature extractor.

According to an embodiment of the present disclosure, a method for inspecting an international express delivery is provided. The method for inspecting the international express delivery includes: an image acquisition step of acquiring a three-dimensional CT image of an express delivery, a CT image processing step of acquiring structured features for the CT image are acquired using the above method for processing the CT image, a feature atlas construction step of constructing a feature atlas for each object and the feature atlas includes the structured features for the CT image and fine-grained field information reflecting contents of a customs declaration form of the express delivery and comprising attribute information, a preset model acquisition step of acquiring a preset feature model for each object in the feature atlas, and a determination step of determining whether the structured features of the object match the preset feature model.

According to the method for inspecting the international express delivery of the present disclosure, the feature atlas construction step includes a text parsing step of acquiring the fine-grained field information of the customs declaration form of the express delivery using a bidirectional encoder representations from transformers (BERT) neural network model, a text and image corresponding step of corresponding the fine-grained field information to the structured features for the image extracted by the feature extractor and physical information of a CT scan image, and a storage step of storing the corresponding content constructed in the text and image corresponding step as the feature atlas.

According to the method for inspecting the international express delivery of the present disclosure, training the BERT neural network model includes a customs declaration form data acquisition step of acquiring data on a plurality of the customs declaration forms as source data, an element extraction step of extracting declaration elements of all of the data on the plurality of the customs declaration forms, an attribute labeling step of segmenting the declaration elements into word segments and the word segments are labeled with attributes based on attribute labels, and a training step of inputting the word segments labeled with the attributes to a BERT network for object attribute training to acquire the BERT neural network model.

According to the method for inspecting the international express delivery of the present disclosure, the determination step includes a matching coefficient calculation step of calculating a matching coefficient between the structured features for the CT image and the preset feature model, and a matching determination step of determining that the object matches customs declaration form information when the matching coefficient is greater than a preset threshold.

According to an embodiments of the present disclosure, an apparatus for processing a CT image is provided. The apparatus for processing the CT image includes: a pre-processing unit, configured to perform uniform sampling and coordinate normalization on three-dimensional data of the CT image to acquire pre-processed data; an object instance acquisition unit, configured to acquire, for the pre-processed data, object instance data acquired after instance segmentation combined with semantic information; and a structured feature acquisition unit, configured to acquire structured features of the object instance data using a feature extractor trained based on a neural network.

According to the apparatus for processing the CT image of the present disclosure, the object instance acquisition unit includes following units respectively configured to: acquire, from the pre-processed data, a feature matrix comprising a global feature and a local feature; perform, on the feature matrix, semantic segmentation and instance segmentation with two decoders respectively; embed a semantic feature obtained after the semantic segmentation into an instance space acquired after the instance segmentation to acquire an instance feature matrix with known semantics; and label different instances with instance labels through unsupervised clustering to acquire the object instance after the instance segmentation.

According to an embodiment of the present disclosure, an apparatus for inspecting an international express delivery is provided. The apparatus includes: an image acquisition unit, configured to acquire a three-dimensional CT image of an express delivery; a CT image processing unit, configured to acquire structured features of the CT image using the above apparatus for processing the CT image; a feature atlas construction unit, configured to construct a feature atlas for each object, the feature atlas including the structured features for the CT image and fine-grained field information reflecting contents of a customs declaration form of the express delivery and comprising attribute information; a preset model acquisition unit, configured to acquire a preset feature model for each object in the feature atlas; and a determination unit, configured to determine whether the structured features of the objects match the preset feature model.

According to the apparatus for inspecting the international express delivery of the present disclosure, the feature atlas construction unit includes: a text parsing unit, configured to acquire the fine-grained field information of the customs declaration form of the express delivery using a BERT neural network model; a text and image corresponding unit, configured to correspond the fine-grained field information to the structured features for the image extracted by the feature extractor and physical information of a CT scan image; and a storage unit, configured to store the corresponding content constructed in the text and image corresponding unit as the feature atlas.

According to the apparatus for inspecting the international express delivery of the present disclosure, the determination unit includes: a matching coefficient calculation unit, configured to calculate a matching coefficient between the structured features for the CT image and the preset feature model; and a matching determination unit, configured to determine that the object matches customs declaration form information when the matching coefficient is greater than a preset threshold.

### BRIEF DESCRIPTION OF THE DRAWINGS

FIG. 1 is a flowchart of a method for processing a CT image according to the present disclosure;

FIG. 2 is a specific flowchart of acquiring an object instance;

FIG. 3 is a flowchart of constructing a feature extractor;

FIG. 4 is a flowchart of a method for inspecting an international express delivery according to the present disclosure;

FIG. 5 is a flowchart of constructing a feature atlas;

FIG. 6 is a flowchart of training a BERT neural network model;

FIG. 7 is a flowchart of a determination process;

FIG. 8 is a block diagram of an apparatus for processing a CT image; and

FIG. 9 is a block diagram of an apparatus for inspecting international express delivery.

### DETAILED DESCRIPTION

Features and exemplary embodiments of various aspects of the present application will be described in detail below. In order to make the objects, technical solutions and advantages of the present application clear, the present application will be further described in detail below with reference to the drawings and specific embodiments. It should be understood that the specific embodiments described herein are only intended to explain the present application, but not to limit the present application. For those of ordinary skilled in the art, the present application may be implemented without some of those specific details. The following description of the embodiments is only for providing a better understanding of the present application by showing examples of the present application.

The present disclosure provides a method for inspecting an international express delivery, and the method for inspecting the international express delivery can inspect more accurately using the three-dimensional image features of the CT image.

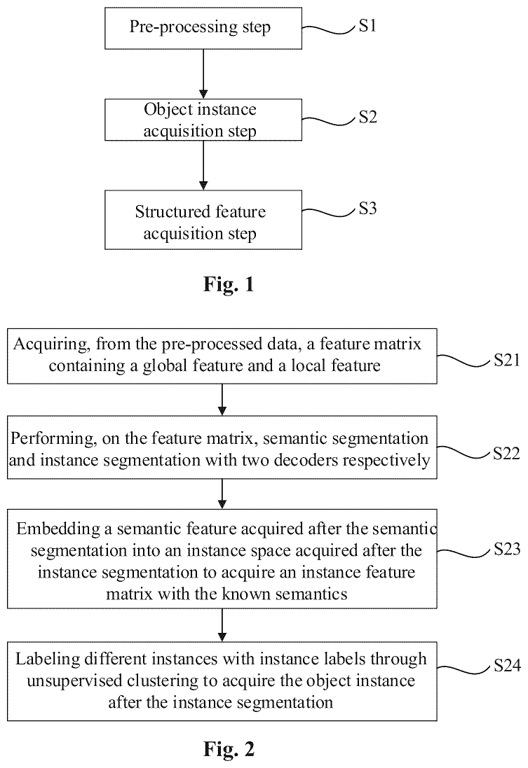

In a first embodiment of the present disclosure, FIG. 1 is a flowchart of a method for processing a CT image according to the present disclosure, and the method for processing the CT image includes: a pre-processing step S1 of performing uniform sampling and coordinate normalization on three-dimensional data of the CT image to acquire the pre-processed data; an object instance acquisition step S2 of acquiring, for the pre-processed data, object instance data acquired after instance segmentation combined with semantic information for the pre-processed data; and a structured feature acquisition step S3 of acquiring structured features of the object instance data using a feature extractor trained based on a neural network.

The three-dimensional CT image is acquired after the international express delivery passes through a CT machine. In the CT image processing, first, in the pre-processing step S1, the uniform sampling and the coordinate normalization are performed on the three-dimensional data of the CT image. In the pre-processing step, since the acquired three-dimensional CT image data has a relatively high resolution, the overhead of the network model is reduced based on needs, and the uniform sampling is performed at equal intervals to acquire the sampling points. The coordinate normalization is performed on the sampling points to normalize the coordinates of the sampling points to (0-1), thereby acquiring the pre-processed data.

FIG. 2 is a specific flowchart of acquiring an object instance. In the object instance acquisition step S2, the object instance data acquired after the instance segmentation combined with the semantic information is acquired for the pre-processed data. Specifically, the object instance acquisition step S2 includes following steps S21 to S24.

In step S21, a feature matrix including a global feature and a local feature is acquired from the pre-processed data. The pre-processed data is input to a pre-trained point cloud feature extraction network to obtain the feature matrix including the global feature and the local feature.

In step S22, semantic segmentation and the instance segmentation are performed on the feature matrix respectively through two decoders. Two decoders are provided, and the same feature matrix is synchronously input to the two decoders to achieve the semantic segmentation and the instance segmentation. The semantic segmentation is performed through one decoder, for example, semantic feature are acquired based on the feature data, and the objects are the milk powder can and the cup. The instance segmentation is performed through the other decoder, for example, the instance features including five milk powder can instances and five water cup instances are acquired based on the feature data.

In step S23, a semantic feature acquired after the semantic segmentation are embedded into an instance space acquired after the instance segmentation to acquire a instance feature matrix with the known semantics. For example, the acquired semantics include the milk powder can and the water cup, and the semantics of the milk powder can and the water cup is embedded into the instances in the instance space acquired after the instance segmentation, thereby acquiring the instance feature matrix with the known semantics.

In step S24, different instances are labeled with instance labels through unsupervised clustering to acquire object instances after the instance segmentation. In the above embodiment, the above sampling points have, for example, the feature vector with the length of 5, that is, the five-dimensional feature vector. The unsupervised clustering is performed on the sampling points based on the feature vector, the points with the same feature vector are clustered, and the labels are added to the instances, thereby acquiring the object instances after the instance segmentation based on the instance labels.

With the above contents, the object instance data is acquired for the pre-processed data.

In the structured feature acquisition step S3, the structured features of the object instance data is obtained using the feature extractor trained based on the neural network.

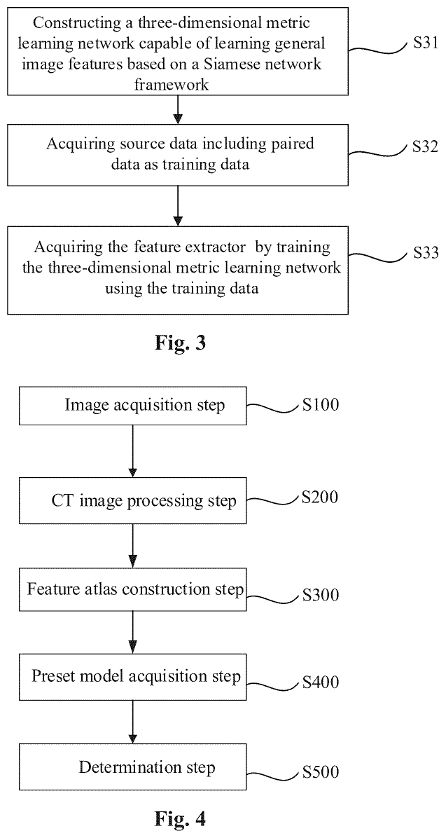

FIG. 3 is a flowchart of constructing a feature extractor, and constructing the feature extractor includes following steps S31 to S33.

In step S31, a three-dimensional metric learning network capable of learning general image features is constructed based on a Siamese network framework. Based on the three-dimensional features of the instance data, the three-dimensional metric learning network capable of learning general image features is designed based on the Siamese network framework. For example, for the milk powder can, its three-dimensional feature is a shape of the milk powder can. In step S32, the source data including paired data is acquired as the training data. The paired data sampled from the source data are trained using the standard optimization techniques and are used as the paired data of the training data, such as paired data indicating that an object A is the same as an object B, and paired data indicating that an object C is different from an object D. In step S33, the feature extractor is acquired by training the three-dimensional metric learning network using the training data. The feature extractor is acquired by training the paired data through the three-dimensional metric learning network.

Returning to step S3, the above trained feature extractor obtains the structured features of the object instance data.

The structured features of the object instance data of the three-dimensional CT image can be acquired for the CT image through the method for processing the CT image. That is, the three-dimensional image features of the image can be acquired through the method for processing the CT image.

A second embodiment of the present disclosure provides a method for inspecting an international express delivery using the method for processing the CT image. FIG. 4 is a flowchart of a method for inspecting an international express delivery according to the present disclosure. The method for inspecting the international express delivery includes: an image acquisition step S100 of acquiring a three-dimensional CT image of an express delivery, a CT image processing step S200 of acquiring the structured features of the CT image using the method for processing the CT image in the above embodiment, a feature atlas construction step S300 of constructing a feature atlas for each object and the feature atlas includes the structured features for the CT image and fine-grained field information reflecting contents of a customs declaration form of the express delivery and including attribute information, a preset model acquisition step S400 of acquiring a preset feature model for each object in the feature atlas, and a determination step S500 of determining whether the structured features match the preset feature model.

In step S100, the three-dimensional CT image is acquired by scanning the international express delivery using the CT machine.

In step S200, the structured features for the CT image are acquired using the method for processing the CT image provided in the above embodiment, whose specific process will not be repeated herein.

In step S300, the feature atlas is constructed for each object, the feature atlas including the fine-grained field information reflecting the contents of the customs declaration form of the express delivery and including the attribute information, and the structured features for the CT image.

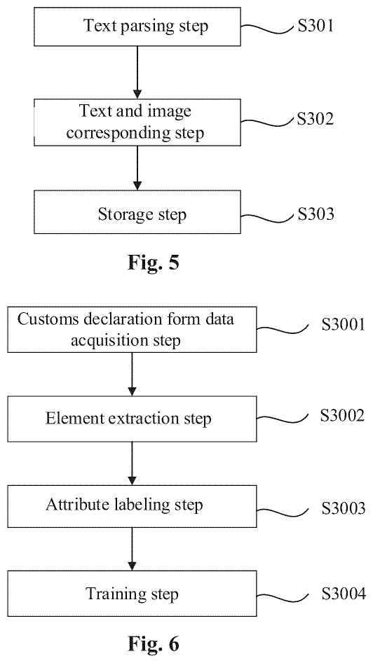

FIG. 5 is a flowchart of constructing a feature atlas. The constructing the feature atlas includes steps S301 to S303. In a text parsing step S301, the fine-grained field information of the customs declaration form of the express delivery is acquired using the BERT neural network model.

FIG. 6 is a flowchart of training a BERT neural network model. The training the BERT neural network model includes steps S3001 to S3004. In a customs declaration form data acquisition step S3001, data on multiple customs declaration forms is acquired as source data. A large amount of data on the customs declaration forms is acquired as the training data. In an element extraction step S3002, declaration elements of all of the data on of the multiple customs declaration form are extracted. In an attribute labeling step S3003, the declaration elements are segmented into word segments and the word segments are labeled with the attributes based on attribute labels. For example, the customs declaration form records 50 Meiji milk powder cans in total, and 100 g/can. The word segmenting results are milk powder, Meiji, 50 cans, 100 g/can. The attribute labels include, for example, the product name, the brand, the quantity, the specification, and the like. The attribute labels after the attribute labeling are milk powder-product name; Meiji-brand; 50 cans-quantity; and 100 g/can-specification. In a training step S3004, the word segments labeled with the attributes are input to the BERT network for the object attribute training to acquire the BERT neural network model. Through the above training, the BERT neural network model can identify the attributes of the words in the customs declaration form, and the fine-grained field including the attribute information such as the product name, the brand, the quantity, and the specification corresponding to the customs declaration form data is acquired by designing a parsing algorithm based on the BERT neural network model.

Returning to FIG. 5, in a text and image corresponding step S302, the fine-grained field information corresponds to the structured features for the image extracted by the feature extractor and physical information of a CT scan image. The fine-grained field information is accurately coupled with the structured features for the image extracted by the feature extractor and the physical information of the CT scan image to construct the feature atlas with text and image dual-modality information. The physical information of the CT scan image of the present disclosure refers to weight information of the object calculated based on density.

In step S303, the corresponding content constructed in the text and image corresponding step S302 are stored as the feature atlas.

Based on the steps in FIG. 5, the feature atlas are constructed for each product on the customs declaration form.

Returning to FIG. 4, in a preset model acquisition step S400, the preset feature model is acquired for each object in the feature atlas. For each object in the feature atlas, the feature model of the object is acquired in advance and stored. Here, the feature model of the object and the objects in the feature atlas can be stored correspondingly in the feature atlas, or the feature models of the object and the objects in the feature atlas can be stored separately in the feature atlas.

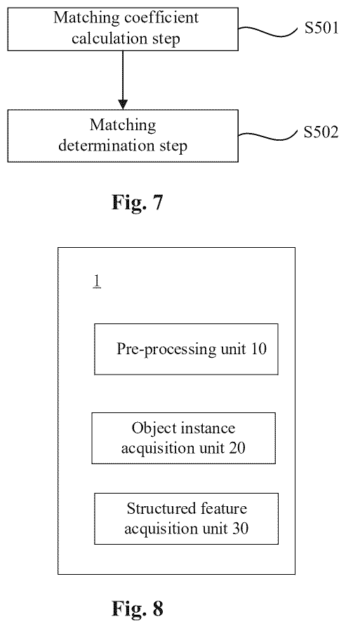

In a determination step S500, it is determined whether the structured features of the object match the preset feature model. FIG. 7 is a flowchart of a determination process, and the determination process includes step S501 and step S502. In a matching coefficient calculation step S501, a matching coefficient between the structured features for the CT image and the preset feature model is calculated. The matching coefficient between feature data of an input CT image and the preset feature model is calculated based on the following formula:

$$r = max [ r ( X , {Y}_{i} ) ] , i = 1 , 2 , 3 , … , n \\ r ( X , {Y}_{i} ) = \frac{Cov [ X , {Y}_{i} )}{\sqrt{Var [ X ] Var [ {Y}_{i} ]}} ,$$

where r denotes the matching coefficient between the feature data of the CT image and the preset feature model, X denotes the feature data of the CT image, Y denotes the preset feature model, r (X, Yᵢ) denotes a correlation coefficient between the feature data of the CT image and the i-th preset feature model, n denotes the number of the preset feature models, Cov(X, Yᵢ) denotes a covariance between the feature data of the CT image and the i-th preset feature model, Var[X] denotes a variance of the feature data of the CT image, and Var[Yᵢ] denotes a variance of the i-th preset feature model.

In a matching determination step S502, it is determined that the object matches customs declaration form information while the matching coefficient is greater than a preset threshold. With the matching coefficient r that is greater than the preset threshold, it is indicated that the image is consistent with the customs declaration form. With the matching coefficient r that is smaller than the preset threshold, it is indicated that the image is inconsistent with the customs declaration form.

According to the above method for inspecting the international express delivery, an intelligent comparison method based on the three-dimensional CT image and the customs declaration form data is provided. Compared with the traditional the manual inspection and determination, the method for inspecting the international express delivery according to the present disclosure greatly increases the efficiency of the machine inspection.

In addition, in the present disclosure, the machine-inspected CT image is accurately determined by effectively using the three-dimensional information, thereby increasing the accuracy for inspecting the international express delivery.

In addition, according to the above method for inspecting the international express delivery, the machine-inspected CT image is accurately described based on the multi-dimensional information such as the density of the objects, the atomic order number, and the graphic, thereby increasing the accuracy for verifying the customs declaration form of the parcels and the machine-inspected CT image.

A third embodiment of the present disclosure further provides an apparatus 1 for processing a CT image. FIG. 8 is a block diagram of an apparatus for processing a CT image, and the apparatus for processing the CT image includes a pre-processing unit 10 configured to perform uniform sampling and coordinate normalization on three-dimensional data of the CT image to acquire pre-processed data, an object instance acquisition unit 20 configured to acquire, for the pre-processed data, object instance data after the instance segmentation combined with the semantic information, and a structured feature acquisition unit 30 configured to obtain structured features of the object instance data using a feature extractor trained based on the neural network. The object instance acquisition unit 20 includes following units respectively configured to: acquire, from the pre-processed data, a feature matrix comprising a global feature and a local feature; perform semantic segmentation and instance segmentation on the feature matrix respectively using two decoders; embed a semantic feature obtained after the semantic segmentation into an instance space acquired after the instance segmentation to acquire an instance feature matrix with known semantics; and label different instances with instance labels through unsupervised clustering to acquire an object instance after the instance segmentation. The specific description of the apparatus for processing the CT image in this embodiment can refer to the description of the method for processing the CT image, which will not be repeated herein.

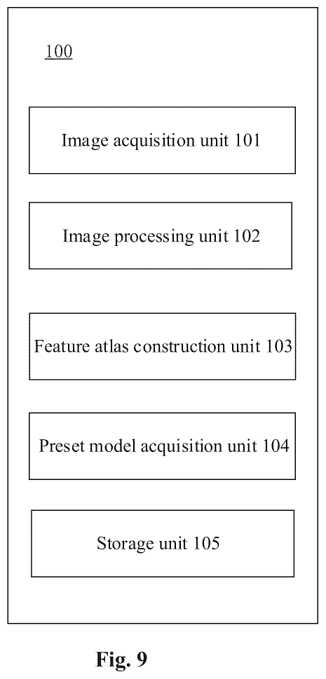

A fourth embodiment of the present disclosure further provides an apparatus 100 for inspecting an international express delivery. FIG. 9 is a block diagram of an apparatus for inspecting an international express delivery, and the apparatus for inspecting an international express delivery includes an image acquisition unit 101 configured to acquire a three-dimensional CT image of an express delivery; a CT image processing unit 102 configured to acquire structured features for the CT image using the apparatus for processing the CT image in the above embodiment; a feature atlas construction unit 103 configured to construct a feature atlas for each object, the feature atlas including fine-grained field information reflecting the contents of the customs declaration form of the express delivery and including the attribute information, and the structured features of the CT image; a preset model acquisition unit 104 configured to acquire a preset feature model for each object in the feature atlas; and a determination unit 105 configured to determine whether the structured features of the object match the preset feature model. The feature atlas construction unit 103 includes: a text parsing unit configured to acquire the fine-grained field information of the customs declaration form of the express delivery using a BERT neural network model; a text and image corresponding unit configured to correspond the fine-grained field information to the structured features for the image extracted by the feature extractor and physical information of a CT scan image; and a storage unit configured to store the corresponding content constructed in the text and image corresponding unit as the feature atlas. The determination unit 105 includes a matching coefficient calculation unit configured to calculate a matching coefficient between the structured features for the CT image and the preset feature model; and a matching determination unit configured to determine that the object matches customs declaration form information while the matching coefficient is greater than a preset threshold. The specific description of the apparatus for inspecting the international express delivery in this embodiment can refer to the description of the method for inspecting the international express delivery, which will not be repeated herein.

According to the apparatus for inspecting the international express delivery, an intelligent comparison method based on the three-dimensional CT image and the customs declaration form data is provided. Compared with the traditional manual inspection and determination, the method for inspecting the international express delivery according to the present disclosure greatly increases the efficiency of the machine inspection.

In addition, in the present disclosure, the machine-inspected CT image is accurately determined by effectively using the three-dimensional information, thereby increasing the accuracy for inspecting the international express delivery.

In addition, according to the apparatus for inspecting the international express delivery, the machine-inspected CT image is accurately described based on the multi-dimensional information such as the density of the object, the atomic order number, and the image, thereby increasing the accuracy for verifying the customs declaration form of the parcels and the machine-inspected CT image.

Some embodiments of the present disclosure provide a non-transitory computer-readable storage medium storing computer instructions. When executed by a processor, the computer instructions causes a processor to perform the above method for processing the CT image.

Some embodiments of the present disclosure provide a non-transitory computer-readable storage medium storing computer instructions. When executed by a processor, the computer instructions causes a processor to perform the above method for inspecting the international express delivery.

The non-transitory storage medium can be a random-access memory (RAM), a read-only memory (ROM), a nonvolatile RAM (NVRAM) such as flash RAM, erasable programmable ROM (EPROM), electrically erasable programmable ROM (EEPROM), registers, hard disk, a removable disk, or a Compact disc read-only memory (CD-ROM); or in any other form of storage medium known in the art.

Some embodiments of the present disclosure provide an apparatus for processing a CT image including a processor and a memory storing computer instructions. When executed by a processor, the computer instructions cause the processor to perform the method for processing the CT image.

Some embodiments of the present disclosure provide an apparatus for processing a CT image including a processor and a memory storing computer instructions. When executed by a processor, the computer instructions cause the processor to perform the method for inspecting the international express delivery.

An apparatus as disclosed herein may be implemented in any combination of hardware with software, and/or with firmware, that is deemed suitable for the intended application. For example, the elements of such an apparatus may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of the elements of the apparatus may be implemented within the same array or arrays. Such an array or arrays may be implemented within one or more chips (for example, within a chipset including two or more chips).

Although the implementations and the specific embodiments of the present disclosure are described above with reference to the drawings, various modifications and variations can be made by those skilled in the art without departing from the spirit and scope of the present disclosure, and such modifications and variations fall within the scope defined by the appended claims.

1. A method for processing a computed tomography (CT) image, comprising:
a pre-processing step of performing uniform sampling and coordinate normalization on three-dimensional data of the CT image to acquire pre-processed data;
an object instance acquisition step of acquiring, for the pre-processed data, object instance data acquired after instance segmentation combined with semantic information; and
a structured feature acquisition step of acquiring structured features of the object instance data using a feature extractor trained based on a neural network.

2. The method for processing the CT image according to claim 1, wherein the object instance acquisition step comprises:
acquiring, from the pre-processed data, a feature matrix comprising a global feature and a local feature;
performing, on the feature matrix, semantic segmentation and instance segmentation with two decoders respectively;
embedding a semantic feature acquired after the semantic segmentation into an instance space acquired after the instance segmentation to acquire an instance feature matrix with known semantics; and
labeling different instances with instance labels through unsupervised clustering to acquire the object instance after the instance segmentation.

3. The method for processing the CT image according to claim 1, wherein constructing the feature extractor comprises:
constructing, based on a Siamese network framework, a three-dimensional metric learning network capable of learning general image features;
acquiring source data comprising paired data as training data; and
training the three-dimensional metric learning network using the training data to acquire the feature extractor.

4. A method for inspecting an international express delivery, comprising:
an image acquisition step of acquiring a three-dimensional CT image of the international express delivery;
a CT image processing step of acquiring structured features for the CT image using the method for processing the CT image according to claim 1;
a feature atlas construction step of constructing a feature atlas for each object, wherein the feature atlas comprises the structured features for the CT image and fine-grained field information reflecting contents of a customs declaration form of the international express delivery and comprising attribute information;
a preset model acquisition step of acquiring a preset feature model for each object in the feature atlas; and
a determination step of determining whether the structured features of the object match the preset feature model.

5. The method for inspecting the international express delivery according to claim 4, wherein the feature atlas construction step comprises:
a text parsing step of acquiring the fine-grained field information of the customs declaration form of the international express delivery using a bidirectional encoder representations from transformers (BERT) neural network model;
a text and image corresponding step of corresponding the fine-grained field information to the structured features for the image extracted by the feature extractor and physical information of a CT scan image; and
a storage step of storing the corresponding content constructed in the text and image corresponding step as the feature atlas.

6. The method for inspecting the international express delivery according to claim 5, wherein training the BERT neural network model comprises:
a customs declaration form data acquisition step of acquiring data on a plurality of the customs declaration forms as source data;
an element extraction step of extracting declaration elements of all of the data on the plurality of the customs declaration forms;
an attribute labeling step of segmenting the declaration elements into word segments and the word segments are labeled with attributes based on attribute labels; and
a training step of inputting the word segments labeled with the attributes are input to a BERT network for object attribute training to acquire the BERT neural network model.

7. The method for inspecting the international express delivery according to claim 4, wherein the determination step comprises:
a matching coefficient calculation step of calculating a matching coefficient between the structured features for the CT image and the preset feature model; and
a matching determination step of determining that the object matches customs declaration form information when the matching coefficient is greater than a preset threshold.

8. An apparatus for processing a CT image, comprising:
a pre-processing unit, configured to perform uniform sampling and coordinate normalization on three-dimensional data of the CT image to acquire pre-processed data;
an object instance acquisition unit, configured to acquire, for the pre-processed data, object instance data acquired after instance segmentation combined with semantic information; and
a structured feature acquisition unit, configured to acquire structured features of the object instance data using a feature extractor trained based on a neural network.

9. The apparatus for processing the CT image according to claim 8, wherein the object instance acquisition unit comprises following units respectively configured to:
acquire, from the pre-processed data, a feature matrix comprising a global feature and a local feature;
perform, on the feature matrix, semantic segmentation and instance segmentation with two decoders respectively;
embed a semantic feature obtained after the semantic segmentation into an instance space acquired after the instance segmentation to acquire an instance feature matrix with known semantics; and
label different instances with instance labels through unsupervised clustering to acquire the object instance after the instance segmentation.

10. An apparatus for inspecting an international express delivery, comprising:
an image acquisition unit, configured to acquire a three-dimensional CT image of the international express delivery;
a CT image processing unit, configured to acquire structured features for the CT image using the apparatus for processing the CT image according to claim 8;
a feature atlas construction unit, configured to construct a feature atlas for each object, wherein the feature atlas comprises the structured features for the CT image and fine-grained field information reflecting contents of a customs declaration form of the international express delivery and comprising attribute information;
a preset model acquisition unit, configured to acquire a preset feature model for each object in the feature atlas; and
a determination unit, configured to determine whether the structured features of the object match the preset feature model.

11. The apparatus for inspecting the international express delivery according to claim 10, wherein the feature atlas construction unit comprises:
a text parsing unit, configured to acquire the fine-grained field information of the customs declaration form of the international express delivery using a BERT neural network model;
a text and image corresponding unit, configured to correspond the fine-grained field information to the structured features for the image extracted by the feature extractor and physical information of a CT scan image; and
a storage unit, configured to store the corresponding content constructed in the text and image corresponding unit as the feature atlas.

12. The apparatus for inspecting the international express delivery according to claim 10, wherein the determination unit comprises:
a matching coefficient calculation unit, configured to calculate a matching coefficient between the structured features for the CT image and the preset feature model; and
a matching determination unit, configured to determine that the object matches customs declaration form information when the matching coefficient is greater than a preset threshold.

13. A non-transitory computer-readable storage medium storing computer instructions, wherein
when executed by a processor, the computer instructions causes a processor to perform a method for processing a CT image, and
the method for processing the CT image comprises:
a pre-processing step where uniform sampling and coordinate normalization are performed on three-dimensional data of the CT image to acquire pre-processed data;
an object instance acquisition step where object instance data acquired after instance segmentation combined with semantic information is acquired for the pre-processed data; and
a structured feature acquisition step where structured features of the object instance data are acquired using a feature extractor trained based on a neural network.

14. A non-transitory computer-readable storage medium storing computer instructions, wherein when executed by a processor, the computer instructions cause a processor to perform the method for inspecting an international express delivery according to claim 4.

15. An apparatus for processing a CT image, comprising:
a processor, and
a memory storing computer instructions, wherein when executed by a processor, the computer instructions cause the processor to perform the method for processing a CT image according to claim 1.

16. An apparatus for processing a CT image, comprising:
a processor, and
a memory storing computer instructions, wherein when executed by a processor, the computer instructions cause the processor to perform the method for inspecting an international express delivery according to claim 4.
